(19) United States
(12) Patent Application Publication
(10) Pub. No.: US 2023/0299342 A1
(43) Pub. Date: Sep. 21, 2023

(54) Thin Solid-State Electrolyte Having High Ionic Conductivity

(71) Applicant: GM GLOBAL TECHNOLOGY OPERATIONS LLC, Detroit, MI (US)

(72) Inventors: Zhe LI, Shanghai (CN); Yong LU, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/884,226

(22) Filed: Aug. 9, 2022

(30) Foreign Application Priority Data
Jan. 28, 2022 (CN) 202210106235.3

(51) Int. Cl. H01M 10/0565; H01M 10/0525

(52) U.S. Cl. CPC H01M 10/0565; H01M 10/0525; H01M 2300/0082

(57) ABSTRACT

A free-standing electrolyte layer for use in an electrochemical cell is provided. The free-standing electrolyte layer includes a plurality of solid-state electrolyte particles, a (first) ionic liquid that surrounds each solid-state electrolyte particle of the plurality of solid-state electrolyte particles, and a plurality of polytetrafluoroethylene fibrils that provides a structural framework for the solid-state electrolyte particles. The free-standing electrolyte layer has an ionic conductivity greater than or equal to about 0.1 mS/cm at 40° C., and a thickness greater than or equal to about 5 micrometers to less than or equal to about 500 micrometers. Each of the polytetrafluoroethylene fibrils of the plurality of polytetrafluoroethylene fibrils has an average length of greater than or equal to about 2 micrometers to less than or equal to about 100 micrometers. The electrochemical cell may include one or more electrodes including a (second) ionic liquid and/or plurality of polytetrafluoroethylene (PTFE) fibrils.

### CROSS-REFERENCE TO RELATED APPLICATIONS

This application claims the benefit and priority of Chinese Application No. 202210106235.3 filed Jan. 28, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12 V start-stop systems), battery-assisted systems (“µBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Free-standing solid-state electrolytes, like sulfide electrolyte films, prepared using wet-slurry techniques commonly have low ionic conductivities (e.g., about 0.28 mS/cm at 40° C.), which unfavorably lowers the power capability of the battery. Free-standing solid-state electrolytes, like sulfide electrolyte films, prepared using dry-press process typically have higher ionic conductivities (e.g., greater than or equal to about 1 mS/cm at 40° C.), but often have larger thicknesses thick (e.g., about 1,000 µm) that decrease the overall energy density of solid-state battery. Accordingly, it would be desirable to develop solid-state electrolyte layers having improved ionic conductivities and mechanical bendabilities, and methods of making the same.

### SUMMARY

This section provides a general summary of the disclosure, and is not a comprehensive disclosure of its full scope or all of its features.

The present disclosure relates to solid-state batteries and methods of forming the same. More particularly, the present disclosure relates to electrolyte layers, for example, free-standing sulfide electrolyte films, having improved ionic conductivities (e.g., about 1.2 mS/cm at 40° C.) and mechanical properties (e.g., greater than or equal to about 5 µm to less than or equal to about 500 µm).

In various aspects, the present disclosure provides a free-standing electrolyte layer for use in an electrochemical cell. The free-standing electrolyte layer may include a plurality of solid-state electrolyte particles, an ionic liquid that surrounds each solid-state electrolyte particle of the plurality of solid-state electrolyte particles, and a plurality of polytetrafluoroethylene (PTFE) fibrils that provides a structural framework for the solid-state electrolyte particles. The free-standing electrolyte layer may have an ionic conductivity greater than or equal to about 0.1 mS/cm at 40° C. The free-standing electrolyte layer may have a thickness greater than or equal to about 5 µm to less than or equal to about 500 µm.

In one aspect, the free-standing electrolyte layer includes greater than or equal to about to about 70 wt.% to less than or equal to about 99 wt.% of the plurality of solid-state electrolyte particles, greater than or equal to about 0.1 wt.% to less than or equal to about 20 wt.% of the ionic liquid, and greater than or equal to about 0.1 to less than or equal to about 10 wt.% of the plurality of polytetrafluoroethylene (PTFE) fibrils.

In one aspect, the plurality of solid-state electrolyte particles may be selected from the group consisting of: solid-state sulfide electrolyte particles, solid-state halide-based electrolyte particles, solid-state hydride-based solid-state electrolyte particles, and combinations thereof.

In one aspect, the ionic liquid may cover greater than or equal to about 2% to less than or equal to about 10 % of the exposed surface each solid-state electrolyte particle of the plurality of solid-state electrolyte particles.

In one aspect, the free-standing electrolyte layer may have a porosity greater than or equal to about 0.1 vol.% to less than or equal to about 40 vol.%.

In one aspect, the ionic liquid may include a cation selected from the group consisting of: li(triglyme) ([Li(G3)]⁺), li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]+), tributylmethylammonium ([N₄₄₄₁]⁺), diallyldimethylammonium ([DADMA]⁺), N-N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfloroethanesulfonyl)imide (BETI), bis(oxalate)borate (BOB), difluoro(oxalate)borate (DFOB), bis(floromalonato)borate (BFMB), and combinations thereof.

In one aspect, the ionic liquid may further include greater than 0 wt.% to less than or equal to about 70 wt.% of a dilute solvent.

In one aspect, the dilute solvent may be selected from the group consisting of: dimethyl carbonate, ethylene carbonate, ethyl acetate, acetonitrile, acetone, toluene, propylene carbonate, diethyl carbonate, 1,2,2-tetrafluoroethyl,2,2,3,3-tetrafluoropropyl ether, and combinations thereof.

In one aspect, each of the polytetrafluoroethylene (PTFE) fibrils of the plurality of polytetrafluoroethylene (PTFE) fibrils may have an average length of greater than or equal to about 2 µm to less than or equal to about 100 µm.

In one aspect, each of the polytetrafluoroethylene (PTFE) fibrils of the plurality of polytetrafluoroethylene (PTFE) fibrils may have a softening point of greater than or equal to about 270° C. to less than or equal to about 380° C.

In one aspect, each of the polytetrafluoroethylene (PTFE) fibrils of the plurality of polytetrafluoroethylene (PTFE) fibrils may a molecular weight of greater than or equal to about 10⁵ g/mol to less than or equal to about 10⁹ g/mol.

In various aspects, the present disclosure provides an electrochemical cell that cycles lithium ions. The electrochemical cell may include an electrolyte layer having an ionic conductivity greater than or equal to about 0.1 mS/cm at 40° C. and a thickness greater than or equal to about 5 µm to less than or equal to about 500 µm. The electrolyte layer may include a plurality of solid-state electrolyte particles, an ionic liquid that covers greater than or equal to about 2% to less than or equal to about 100 % of the exposed surface each solid-state electrolyte particle of the plurality of solid-state electrolyte particles, and a plurality of polytetrafluoroethylene (PTFE) fibrils that provides a structural framework for the solid-state electrolyte particles. Each of the polytetrafluoroethylene (PTFE) fibrils of the plurality of polytetrafluoroethylene (PTFE) fibrils may have an average length of greater than or equal to about 2 µm to less than or equal to about 100 µm.

In one aspect, the plurality of solid-state electrolyte particles may be selected from the group consisting of: solid-state sulfide electrolyte particles, solid-state halide-based electrolyte particles, solid-state hydride-based solid-state electrolyte particles, and combinations thereof.

In one aspect, plurality of solid-state electrolyte particles may be a plurality of first solid-state electrolyte particles, the ionic liquid may be a first ionic liquid, and the plurality of polytetrafluoroethylene (PTFE) fibrils may be a first plurality of polytetrafluoroethylene (PTFE) fibrils. In such instances, the electrochemical cell may include at least one electrode. The at least one electrode may include a plurality of solid-state electroactive particles, a plurality of second solid-state electrolyte particles, a second ionic liquid that surrounds each of the solid-state electroactive particles and the second solid-state electrolyte particles, and a second plurality of polytetrafluoroethylene (PTFE) fibrils that provides a structural framework for the solid-state electroactive particles and the second solid-state electrolyte particle.

In one aspect, the at least one electrode may be an at least one first electrode, and the plurality of solid-state electroactive particles may be a plurality of first solid-state electroactive particles. In such instances, the electrochemical cell may further include at least one second electrode. The at least one second electrode may include a plurality of second solid-state electroactive particles, a plurality of third solid-state electrolyte particles, a third ionic liquid that surrounds each of the solid-state electroactive particles and the third solid-state electrolyte particles, and a third plurality of polytetrafluoroethylene (PTFE) fibrils that provides a structural framework for the solid-state electroactive particles and the third solid-state electrolyte particle. The second solid-state electroactive particles may be different from the first solid-state electroactive particles.

In one aspect, the first ionic liquid, the second ionic liquid, and the third ionic liquid may each include a cation selected from the group consisting of: li(triglyme) ([Li(G3)]⁺), li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]+), tributylmethylammonium ([N₄₄₄₁]⁺), diallyldimethylammonium ([DADMA]⁺), N-N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfloroethanesulfonyl)imide (BETI), bis(oxalate)borate (BOB), difluoro(oxalate)borate (DFOB), bis(floromalonato)borate (BFMB), and combinations thereof.

In one aspect, at least one of the first ionic liquid, the second ionic liquid, and the third ionic liquid may include a dilute solvent. The dilute solvent may be selected from the group consisting of: dimethyl carbonate, ethylene carbonate, ethyl acetate, acetonitrile, acetone, toluene, propylene carbonate, diethyl carbonate, 1,2,2-tetrafluoroethyl,2,2,3,3-tetrafluoropropyl ether, and combinations thereof.

In various aspects, the present disclosure provides a free-standing electrolyte layer for use in an electrochemical cell. The free-standing electrolyte layer may include a plurality of solid-state electrolyte particles, an ionic liquid, and a plurality of polytetrafluoroethylene (PTFE) fibrils that provides a structural framework for the solid-state electrolyte particles. The plurality of solid-state electrolyte particles may include solid-state sulfide electrolyte particles. Each of the polytetrafluoroethylene (PTFE) fibrils of the plurality of polytetrafluoroethylene (PTFE) fibrils may have an average length of greater than or equal to about 2 µm to less than or equal to about 100 µm. The free-standing electrolyte layer may have an ionic conductivity greater than or equal to about 0.1 mS/cm at 40° C. The free-standing electrolyte layer may have a thickness greater than or equal to about 5 µm to less than or equal to about 500 µm. The free-standing electrolyte layer may have a porosity greater than or equal to about 0.1 vol.% to less than or equal to about 40 vol.%.

In one aspect, the plurality of solid-state electrolyte particles may further include solid-state halide-based electrolyte particles, solid-state hydride-based solid-state electrolyte particles, or a combination of solid-state halide-based electrolyte particles and solid-state hydride-based solid-state electrolyte particles.

In one aspect, the ionic liquid may cover greater than or equal to about 2% to less than or equal to about 100% of the exposed surface each solid-state electrolyte particle of the plurality of solid-state electrolyte particles.

In one aspect, the plurality of polytetrafluoroethylene (PTFE) fibrils may be prepared from a starting polytetrafluoroethylene (PTFE) material having an average particle size greater than or equal to about 2 µm to less than or equal to about 2,000 µm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery in accordance with various aspects of the present disclosure;

FIG. 2 is a scanning electron microscopy image of a free-standing electrolyte layer prepared in accordance with various aspects of the present disclosure;

FIG. 3 is an illustration of another example solid-state battery in accordance with various aspects of the present disclosure;

FIG. 4 is an illustration of another example solid-state battery in accordance with various aspects of the present disclosure;

FIG. 5 is an illustration of another example solid-state battery in accordance with various aspects of the present disclosure;

FIG. 6A is a graphical illustration demonstrating X-ray powder diffraction (XRD) patterns of comparable free-standing electrolyte layers; and

FIG. 6B is a graphical illustration demonstrating the ionic conductivity of an example free-standing electrolyte layer prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

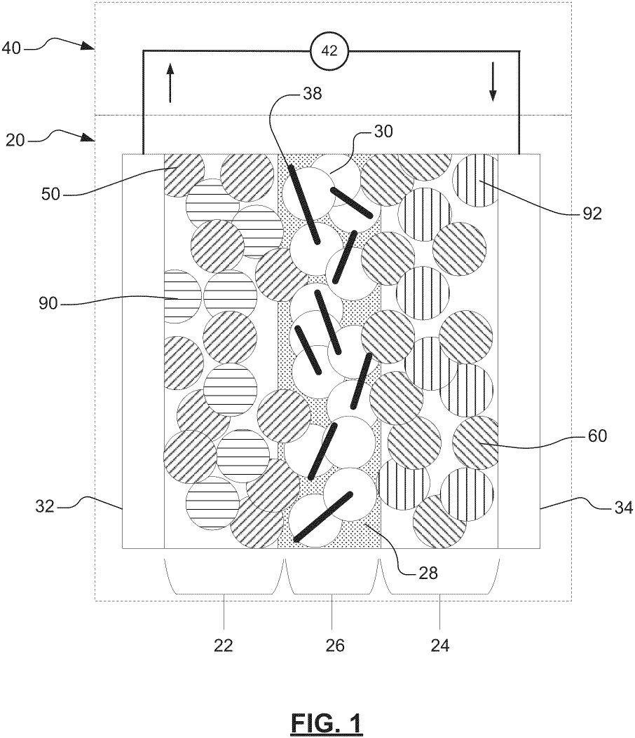

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30, an ionic liquid 28, and a plurality of polytetrafluoroethylene (PTFE) fibrils 38. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al-Cu), nickel-copper (Ni-Cu), stainless steel-copper (SS-Cu), aluminum-nickel (Al-Ni), aluminum-stainless steel (Al-SS), and nickel-stainless steel (Ni-SS). In certain variatioXns, the first bipolar current collector 32 and/or second bipolar current collectors 34 may be pre-coated, such as graphene or carbon-coated aluminum current collectors.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Though the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the electrolyte layer 26 provides electrical separation—preventing physical contact—between the negative electrode 22 and the positive electrode 24. The electrolyte layer 26 also provides a minimal resistance path for internal passage of lithium ions. The electrolyte layer 26 may be a free-standing membrane. That is, the electrolyte layer 26 may be self-supporting with structural integrity and may be handled as an independent layer (e.g., removed from a substrate) rather than a coating formed on another element.

In various aspects, the electrolyte layer 26 includes a first plurality of solid-state electrolyte particles 30, an ionic liquid 28 that surrounds and substantially coats the solid-state electrolyte particles 30, and a plurality of polytetrafluorethylene (PTFE) fibrils 38 that provides a structural framework for the solid-state electrolyte particles 30. For example, the electrolyte layer 26 may be in the form of a layer or a composite that comprises the first plurality of solid-state electrolyte particles 30, the ionic liquid 28, and the polytetrafluorethylene (PTFE) fibrils 38. The electrolyte layer 26 may be in the form of a layer having a thickness greater than or equal to about 2 µm to less than or equal to about 200 µm, optionally greater than or equal to about 10 µm to less than or equal to about 100 µm, optionally about 40 µm, and in certain aspects, optionally about 20 µm. The electrolyte layer 26 may be in the form of a layer having a thickness greater than or equal to 2 µm to less than or equal to 200 µm, optionally greater than or equal to 10 µm to less than or equal to 100 µm, optionally 40 µm, and in certain aspects, optionally 20 µm.

The electrolyte layer 26 may include greater than or equal to about 70 wt.% to less than or equal to about 99 wt. of the solid-state electrolyte particles 30, greater than or equal to about 0.1 wt.% to less than or equal to about 10 wt.% of the polytetrafluorethylene (PTFE) fibrils 38, and greater than or equal to about 0.1 wt.% to less than or equal to about 20 wt.% of the ionic liquid 28. The electrolyte layer 26 may include greater than or equal to 70 wt.% to less than or equal to 99 wt. of the solid-state electrolyte particles 30, greater than or equal to 0.1 wt.% to less than or equal to 10 wt.% of the polytetrafluorethylene (PTFE) fibrils 38, and greater than or equal to 0.1 wt.% to less than or equal to 20 wt.% of the ionic liquid 28.

In various aspects, the solid-state electrolyte particles 30 are selected so as to have a high ionic conductivity. For example, the solid-state electrolyte particles 30 may have an ionic conductivity greater than or equal to about 0.1 mS/cm to less than or equal to about 50 mS/cm at 25° C. The solid-state electrolyte particles 30 may have an ionic conductivity greater than or equal to 0.1 mS/cm to less than or equal to 50 mS/cm at 25° C. In certain variations, the solid-state electrolyte particles 30 may have an average particle diameter greater than or equal to about 0.02 µm to less than or equal to about 20 µm, optionally greater than or equal to about 0.1 µm to less than or equal to about 10 µm, and in certain aspects, optionally greater than or equal to about 0.1 µm to less than or equal to about 1 µm. The solid-state electrolyte particles 30 may have an average particle diameter greater than or equal to 0.02 µm to less than or equal to 20 µm, optionally greater than or equal to 0.1 µm to less than or equal to 10 µm, and in certain aspects, optionally greater than or equal to 0.1 µm to less than or equal to 1 µm. For example, the solid-state electrolyte particles 30 may comprise one or more sulfide-based particles, halide-based particles, hydride-based particles, or other solid-state electrolyte particles, for example, having low grain-boundary resistance.

In various aspects, the sulfide-based particles may include pseudobinary sulfide systems, pseudotemary sulfide systems, and/or pseudoquaternary sulfide systems. Example pseudobinary sulfide systems include systems include Li₂S-P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S-Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4 LiI • 0.6 Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In various aspects, the halide-based particles may include, for example only, Li₃YCl₆, Li₃InCl₆, Li₃YBr₆, LiI, Li₂CdC₁₄, Li₂MgCl₄, LiCdI₄, Li₂ZnI₄, Li₃OCl, and combinations thereof; and the hydride-based particles may include, for example only, LiBH₄, LiBH₄—LiX (where x = Cl, Br, or I), LiNH₂, Li₂NH, LiBH₄—LiNH₂, Li₃AlH₆, and combinations thereof.

The ionic liquid 28 may permeate voids and/or grain boundaries between the solid-state electrolyte particles 30. For example, the ionic liquid 28 may be selected to so as to have a strong affinity for the solid-state electrolyte particles 30 such that the ionic liquid 28 surrounds and substantially coats the solid-state electrolyte particles 30. The ionic liquid 28 may form a discontinuous or continuous coating around the solid-state electrolyte particles 30. For example, the ionic liquid 28 may cover greater than or equal to about 2 % to less than or equal to about 100 % of the exposed surface each solid-state electrolyte particle 30, and the solid-state electrolyte layer 26 including the ionic liquid 28 may have a porosity greater than or equal to about 0.11 vol.% to less than or equal to about 40 vol.%. In certain variations, the ionic liquid 28 may build ion transfer bridges at interfaces between the solid-state electrolyte particles 30, for example, by wetting interfaces or voids between the solid-state electrolyte particles 30.

The ionic liquid 28 includes a cation and an anion, and in certain variations, a diluent solvent. For example, the ionic liquid 28 may include greater than or equal to about 1 wt.% to less than or equal to about 90 wt.%, and in certain aspects, optionally greater than or equal to about 10 wt.% to less than or equal to about 70 wt.%, of the cation; greater than or equal to about 1 wt.% to less than or equal to about 90 wt.%, and in certain aspects, optionally greater than or equal to about 10 wt.% to less than or equal to about 70 wt.%, of the anion, and greater than or equal to 0 wt.% to less than or equal to about 80 wt.%, and in certain aspects, optionally greater than or equal to about 0 wt.% to less than or equal to about 60 wt.%, of the diluent solvent.

In certain variations, the cations may be selected from the group consisting of: li(triglyme) ([Li(G3)]⁺), li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]+), tributylmethylammonium ([N₄₄₄₁]⁺), diallyldimethylammonium ([DADMA]⁺), N-N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof.

In certain variations, the anions may be selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfloroethanesulfonyl)imide (BETI), bis(oxalate)borate (BOB), difluoro(oxalate)borate (DFOB), bis(floromalonato)borate (BFMB), and combinations thereof.

The dilute solvent may be selected so as to decrease the viscosity of the ionic liquid and/or improve the lithium ionic conductivity of the electrolyte layer 26. For example, in certain variations, the dilute solvent may be selected from the group consisting of: dimethyl carbonate, ethylene carbonate, ethyl acetate, acetonitrile, acetone, toluene, propylene carbonate, diethyl carbonate, 1,2,2-tetrafluoroethyl,2,2,3,3-tetrafluoropropyl ether, and combinations thereof. It may be desirable for the ionic liquid to have a lithium ionic conductivity of the electrolyte layer 26 may be greater than or equal to about 0.1 mS/cm to less than or equal to about 20 mS/cm at 40° C., and in certain aspects, optionally greater than or equal to about 0.1 mS/cm to less than or equal to about 10 mS/cm at 40° C.

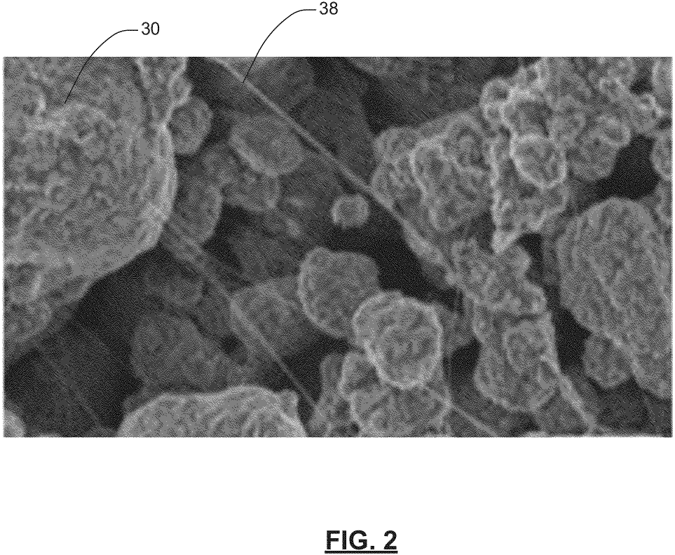

The polytetrafluorethylene (PTFE) fibrils 38 provides a structural framework for the solid-state electrolyte particles 30. For example, as illustrated in FIG. 2, the polytetrafluorethylene (PTFE) fibrils 38 may span between, and in certain variations, connect, the solid-state electrolyte particles 30. In certain variations, the starting polytetrafluorethylene (PTFE) material or binder (that generates or forms the polytetrafluorethylene (PTFE) fibrils 38) may have an average particle size greater than or equal to about 2 µm to less than or equal to about 2,000 µm, and in certain aspects, optionally greater than or equal to about 400 µm to less than or equal to about 700 µm. The starting polytetrafluorethylene (PTFE) material (that generates the polytetrafluorethylene (PTFE) fibrils 38) may an average particle size greater than or equal to 2 µm to less than or equal to 2,000 µm, and in certain aspects, optionally greater than or equal to 400 µm to less than or equal to 700 µm.Notably, polyvinylidene fluoride (PVDF), polypropylene (PP), and polyethylene (PE) materials have not been found to prepare usable fibrils.

The polytetrafluoroethylene (PTFE) fibrils 38 may have an average length of greater than or equal to about 2 µm to less than or equal to about 100 µm.The polytetrafluoroethylene (PTFE) fibrils 38 may have an average length of greater than or equal to about 2 µm to less than or equal to about 100 µm.The polytetrafluorethylene (PTFE) fibrils 38 may have a softening point of greater than or equal to about 270° C. to less than or equal to about 380° C. The polytetrafluorethylene (PTFE) fibrils 38 may have a softening point of greater than or equal to 270° C. to less than or equal to 380° C. The molecular weight of the polytetrafluorethylene (PTFE) fibrils 38 may be greater than or equal to about 10⁵ g/mol to less than or equal to about 10⁹ g/mol. The molecular weight of the polytetrafluorethylene (PTFE) fibrils 38 may be greater than or equal to 10⁵ g/mol to less than or equal to 10⁹ g/mol.

With renewed reference to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. In each variation, the negative electrode 22 may be in the form of a layer having a thickness greater than or equal to about 10 µm to less than or equal to about 5,000 µm, and in certain aspects, optionally greater than or equal to about 10 µm to less than or equal to about 100 µm.The negative electrode 22 may be in the form of a layer having a thickness greater than or equal to 10 µm to less than or equal to 5,000 µm, and in certain aspects, optionally greater than or equal to 10 µm to less than or equal to 100 µm.

The negative electrode 22 may include greater than or equal to about 30 wt.% to less than or equal to about 98 wt.%, and in certain aspects, optionally greater than or equal to about 50 wt.% to less than or equal to about 95 wt.%, of the negative solid-state electroactive particles 50, and greater than or equal to 0 wt.% to less than or equal to about 50 wt.%, and in certain aspects, optionally greater than or equal to about 5 wt.% to less than or equal to about 20 wt.%, of the second plurality of solid-state electrolyte particles 90. The negative electrode 22 may include greater than or equal to 30 wt.% to less than or equal to 98 wt.%, and in certain aspects, optionally greater than or equal to 50 wt.% to less than or equal to 95 wt.%, of the negative solid-state electroactive particles 50, and greater than or equal to 0 wt.% to less than or equal to 50 wt.%, and in certain aspects, optionally greater than or equal to 5 wt.% to less than or equal to 20 wt.%, of the second plurality of solid-state electrolyte particles 90.

The negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; and/or metal sulfides, such as FeS. The negative solid-state electroactive particles 50 may be selected from the group including, for example only, lithium, graphite, graphene, hard carbon, soft carbon, carbon nanotubes, silicon, silicon-containing alloys, tin-containing alloys, and/or other lithium-accepting materials.

The second plurality of solid-state electrolyte particles 90 may be the same as or different from the first plurality of solid-state electrolyte particles 30. For example, the second plurality of solid-state electrolyte particles 90 may comprise one or more sulfide-based particles, halide-based particles, hydride-based particles, or other solid-state electrolyte particles, for example, having low grain-boundary resistance.

Although not illustrated, in certain variations, the negative electrode 22 may further include one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as sodium carboxymethyl cellulose (CMC), styrene ethylene butylene styrene copolymer (SEBS), styrene butadiene styrene copolymer (SBS), polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

In various aspects, the negative electrode 22 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The negative electrode 22 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. In each variation, the positive electrode 24 may have be in the form of a layer having a thickness greater than or equal to about 10 µm to less than or equal to about 5,000 µm, and in certain aspects, optionally greater than or equal to about 10 µm to less than or equal to about 100 µm. The positive electrode 24 may have be in the form of a layer having a thickness greater than or equal to 10 µm to less than or equal to 5,000 µm, and in certain aspects, optionally greater than or equal to 10 µm to less than or equal to 100 µm.

The positive electrode 24 may include greater than or equal to about 30 wt.% to less than or equal to about 98 wt.%, and in certain aspects, optionally greater than or equal to about 50 wt.% to less than or equal to about 95 wt.%, of the positive solid-state electroactive particles 60, and greater than or equal to 0 wt.% to less than or equal to about 50 wt.%, and in certain aspects, optionally greater than or equal to about 5 wt.% to less than or equal to about 20 wt.%, of the third plurality of solid-state electrolyte particles 92. The positive electrode 24 may include greater than or equal to 30 wt.% to less than or equal to 98 wt.%, and in certain aspects, optionally greater than or equal to 50 wt.% to less than or equal to 95 wt.%, of the positive solid-state electroactive particles 60, and greater than or equal to 0 wt.% to less than or equal to 50 wt.%, and in certain aspects, optionally greater than or equal to 5 wt.% to less than or equal to 20 wt.%, of the third plurality of solid-state electrolyte particles 92.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0 ≤ x ≤ 1 and 0 ≤ y ≤ 1), LiNiₓMn_{y}Al_{1-x-y}O₂ (where 0 < x ≤ 1 and 0 < y ≤ 1), LiNiₓMn₁₋ₓO₂ (where 0 ≤ x ≤ 1), and Li₁₊ₓMO₂ (where 0 ≤ x ≤ 1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. The positive solid-state electroactive particles 60 may comprise one or more positive electroactive materials selected from the group consisting of LiCoO₂, LiNiₓMn_{y}Co_{1-x-y}O₂ (where 0 ≤ x ≤ 1 and 0 ≤ y < 1), LiNiₓMn₁₋ₓO₂ (where 0 ≤ x ≤ 1), Li₁₊ₓMO₂ (where 0 ≤ x ≤ 1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

The third plurality of solid-state electrolyte particles 92 may be the same as or different from the first and/or second pluralities of solid-state electrolyte particles 30, 90. For example, the third plurality of solid-state electrolyte particles 92 may comprise one or more sulfide-based particles, halide-based particles, hydride-based particles, or other solid-state electrolyte particles, for example, having low grain-boundary resistance.

Although not illustrated, in certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) be optionally intermingled with binders, such as sodium carboxymethyl cellulose (CMC), styrene ethylene butylene styrene copolymer (SEBS), styrene butadiene styrene copolymer (SBS), polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

In various aspects, the positive electrode 24 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The positive electrode 24 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

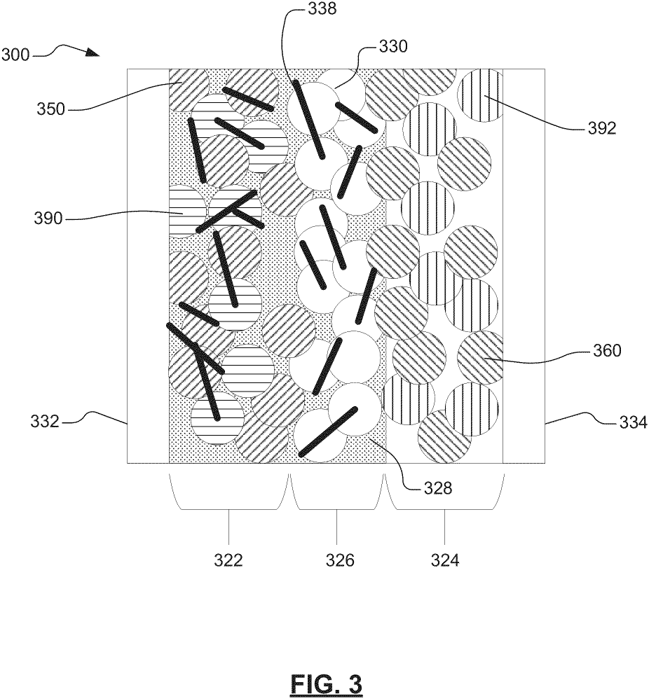

In various aspects, the negative electrode 22, as illustrated in FIG. 1, may be prepared using wet-coating process, without ionic liquids. However, in other variations, a negative electrode may be prepared using a solvent-free process. For example, FIG. 3 illustrates a negative electrode 322 including an ionic liquid 328 and/or polytetrafluoroethylene (PTFE) binder 338, similar to the electrolyte layer 26 illustrated in FIG. 1.

FIG. 3 is an exemplary and schematic illustration of another solid-state electrochemical cell unit (also referred to as a “solid-state battery” and/or “battery”) 300 that cycles lithium ions. Similar to the battery 20 illustrated in FIG. 1, the battery 300 includes a negative current collector 332, a negative electrode (i.e., anode) 322, a positive current collector 334, a positive electrode (i.e., cathode) 324, and an electrolyte layer 326 that occupies a space defined between the two or more electrodes. Like the positive electrode 24 illustrated in FIG. 1, the positive electrode 324 illustrated in FIG. 3 is defined by a plurality of the positive solid-state electroactive particles 360. In certain instances, the positive electrode 324 may a composite comprising a mixture of the positive solid-state electroactive particles 360 and a first plurality of solid-state electrolyte particles 392.

Like the electrolyte layer 26 illustrated in FIG. 1, the electrolyte layer 326 illustrated in FIG. 3 provides electrical separation-preventing physical contact-between the negative electrode 322 and the positive electrode 324. The electrolyte layer 326 may include a second plurality of solid-state electrolyte particles 330, an ionic liquid 328 that surrounds and substantially coats the solid-state electrolyte particles 330, and a plurality of polytetrafluorethylene (PTFE) fibrils 338 that provide a structural framework for the solid-state electrolyte particles 30.

Like the negative electrode 22 illustrated in FIG. 1, the negative electrode 322 illustrated in FIG. 3 is defined by a plurality of negative solid-state electroactive particles 350, and in certain instances, the negative electrode 322 may be a composite comprising a mixture of the negative solid-state electroactive particles 350 and a third plurality of solid-state electrolyte particles 390. As illustrated, the negative electrode 322, as illustrated in FIG. 3, may further include the ionic liquid 328 and the plurality of polytetrafluorethylene (PTFE) fibrils 338. The ionic liquid 328 may surround and/or coat the negative solid-state electroactive particles 350 (and the optional a third plurality of solid-state electrolyte particles 390). The plurality of polytetrafluorethylene (PTFE) fibrils 338 that provide a structural framework for the negative electrode 322.

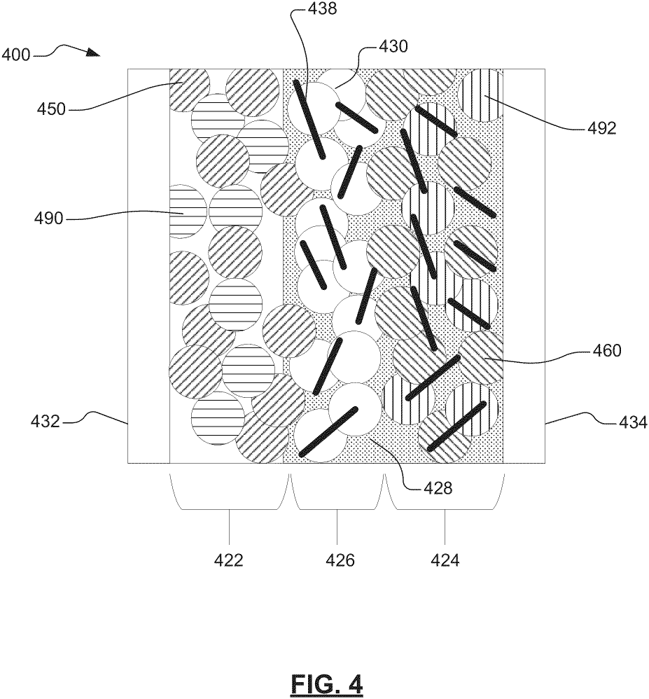

In various aspects, the positive electrode 24, as illustrated in FIG. 1, may be prepared using wet-coating process, without ionic liquids. However, in other variations, a positive electrode may be prepared using a solvent-free process. For example, FIG. 4 illustrates a positive electrode 424 including an ionic liquid 428 and/or polytetrafluoroethylene (PTFE) binder 438, similar to the electrolyte layer 26 illustrated in FIG. 1 and/or the negative electrode 322 illustrated in FIG. 3.

FIG. 4 is an exemplary and schematic illustration of another solid-state electrochemical cell unit (also referred to as a “solid-state battery” and/or “battery”) 400 that cycles lithium ions. Similar to the battery 20 illustrated in FIG. 1 and/or the battery illustrated in FIG. 3, the battery 400 includes a negative electrode (i.e., anode) 422, a positive electrode (i.e., cathode) 424, and an electrolyte layer 426 that occupies a space defined between the two or more electrodes.

Like the negative electrode 22 illustrated in FIG. 1, the negative electrode 422 illustrated in FIG. 4 is defined by a plurality of negative solid-state electroactive particles 450. In certain instances, the negative electrode 422 may be a composite comprising a mixture of the positive solid-state electroactive particles 450 and a first plurality of solid-state electrolyte particles 490.

Like the electrolyte layer 26 illustrated in FIG. 1 and/or the electrolyte layer 326 illustrated in FIG. 3, the electrolyte layer 426 illustrated in FIG. 4 provides electrical separation-preventing physical contact-between the negative electrode 422 and the positive electrode 424. The electrolyte layer 426 may include a second plurality of solid-state electrolyte particles 430, an ionic liquid 428 that surrounds and substantially coats the solid-state electrolyte particles 430, and a plurality of polytetrafluorethylene (PTFE) fibrils 438 that provide a structural framework for the solid-state electrolyte particles 430.

Like the positive electrode 42 illustrated in FIG. 1, the positive electrode 424 illustrated in FIG. 4 is defined by a plurality of positive solid-state electroactive particles 460, and in certain instances, the positive electrode 424 may be a composite comprising a mixture of the positive solid-state electroactive particles 460 and a third plurality of solid-state electrolyte particles 492. As illustrated, the positive electrode 424 as illustrated in FIG. 4 may further include the ionic liquid 428 and the plurality of polytetrafluorethylene (PTFE) fibrils 438. The ionic liquid may surround and/or coat the positive solid-state electroactive particles 460 (and the optional a third plurality of solid-state electrolyte particles 492). The plurality of polytetrafluorethylene (PTFE) fibrils 438 may provide a structural framework for the positive electrode 424.

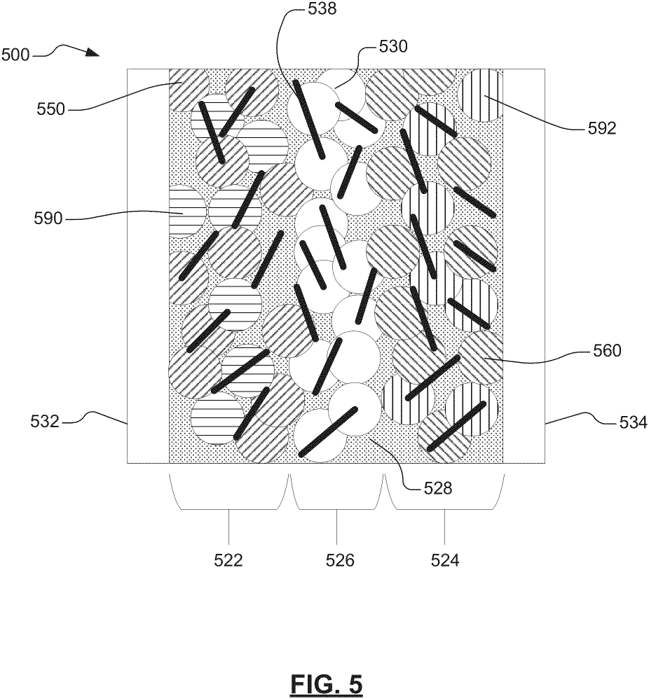

In various aspects, the positive electrode 24 and/or the negative electrode 22, as illustrated in FIG. 1, may be prepared using wet-coating process, without ionic liquids. However, in other variations, a positive electrode and/or a negative electrode may be prepared using a solvent-free process. For example, FIG. 5 illustrates a battery 500 having a negative electrode 522 including an ionic liquid 528 and/or polytetrafluoroethylene (PTFE) binder 538, similar to the solid-state electrolyte layer, and a positive electrode 524 including an ionic liquid 528 and/or polytetrafluoroethylene (PTFE) binder 538, similar to the solid-state electrolyte layer.

FIG. 5 is an exemplary and schematic illustration of another solid-state electrochemical cell unit (also referred to as a “solid-state battery” and/or “battery”) 400 that cycles lithium ions. Similar to the battery 20 illustrated in FIG. 1 and/or the battery illustrated in FIG. 3 and/or the battery illustrated in FIG. 4, the battery 400 includes a negative electrode (i.e., anode) 422, a positive electrode (i.e., cathode) 424, and an electrolyte layer 426 that occupies a space defined between the two or more electrodes.

Like the negative electrode 22 illustrated in FIG. 1 and/or the negative electrode 322 illustrated in FIG. 3, the negative electrode 522 illustrated in FIG. 5 is defined by a plurality of negative solid-state electroactive particles 550, and in certain instances, the negative electrode 522 may be a composite comprising a mixture of the negative solid-state electroactive particles 550 and a first plurality of solid-state electrolyte particles 590. As illustrated, the negative electrode 522 as illustrated in FIG. 5 may further include an ionic liquid 528 that surrounds and substantially coats the negative solid-state electroactive particles 350 (and the optional a third plurality of solid-state electrolyte particles 390), and a plurality of polytetrafluorethylene (PTFE) fibrils 538 that span between, and in certain variations, connect, the negative solid-state electroactive particles 350.

Like the electrolyte layer 26 illustrated in FIG. 1 and/or the electrolyte layer 326 illustrated in FIG. 3 and/or the electrolyte layer 426 illustrated in FIG. 4, the electrolyte layer 526 illustrated in FIG. 5 provides electrical separation-preventing physical contact-between the negative electrode 522 and the positive electrode 524. The electrolyte layer 526 may include a second plurality of solid-state electrolyte particles 530, an ionic liquid 528 that surrounds and substantially coats the solid-state electrolyte particles 530, and a plurality of polytetrafluorethylene (PTFE) fibrils 538 that provide a structural framework for the solid-state electrolyte particles 530.

Like the positive electrode 42 illustrated in FIG. 1 and/or the positive electrode 442 illustrated in FIG. 4, the positive electrode 524 illustrated in FIG. 5 is defined by a plurality of positive solid-state electroactive particles 560, and in certain instances, the positive electrode 524 may be a composite comprising a mixture of the positive solid-state electroactive particles 560 and a third plurality of solid-state electrolyte particles 592. As illustrated, the positive electrode 524 as illustrated in FIG. 5 may further include an ionic liquid 528 that surrounds and substantially coats the positive solid-state electroactive particles 560 (and the optional a third plurality of solid-state electrolyte particles 592), and a plurality of polytetrafluorethylene (PTFE) fibrils 538 that provide a structural framework for the positive solid-state electroactive particles 560 (and the optional third plurality of solid-state electrolyte particles 592).

In various aspects, the present disclosure provides an example method for fabricating an electrolyte layer, like the electrolyte layer 26 illustrated in FIG. 1 and/or the electrolyte layer 326 illustrated in FIG. 3 and/or the electrolyte layer 426 illustrated in FIG. 4 and/or the electrolyte layer 426 illustrated in FIG. 4. For example, an example method for forming an electrolyte layer may include contacting an ionic liquid (for example, LiTFSI-triglyme, 1:1 molar ratio), a polytetrafluorethylene (PTFE) binder, and solid-state electrolyte particles (for example, Li₆PS₅Cl (LPSCl)). The contacting may include simultaneously or concurrently mixing and/or shearing the ionic liquid, the polytetrafluorethylene (PTFE) binder, and the solid-state electrolyte particles. For example, the ionic liquid, the polytetrafluorethylene (PTFE) binder, and the solid-state electrolyte particles may be mixed and/or sheared for about 5 minutes. During the mixing and/or shearing process the ionic liquid may surround and coat the solid-state electrolyte particles and the polytetrafluorethylene (PTFE) binder may form a plurality of polytetrafluorethylene (PTFE) fibrils that span between, and in certain variations, connect, the solid-state electrolyte particles. In various aspects, the method may further include rolling out the mixture (for example, about 10 times), so to form an electrolyte layer. The skilled artisan would appreciate that similar methods may be sued to prepare a negative electrode including an ionic liquid and/or polytetrafluorethylene (PTFE) fibrils, such as illustrated in FIG. 3 and/or FIG. 5, and/or a positive electrode including an ionic liquid and/or polytetrafluorethylene (PTFE) fibrils, such as illustrated in FIG. 4 and/or FIG. 5.

Certain features of the current technology are further illustrated in the following non-limiting examples.

### Example 1

Example battery cells may be prepared in accordance with various aspects of the present disclosure. For example, an example electrolyte layer 710 may include a plurality of solid-state electrolyte particles (for example, Li₆PS₅Cl (LPSCl)), an ionic liquid (for example, LiTFSI-triglyme, 1:1 molar ratio), and a plurality of polytetrafluorethylene (PTFE) fibrils, like battery 20 illustrated in FIG. 1. A comparative electrolyte layer 720 may include a plurality of solid-state electrolyte particles (for example, LiₑPS₅Cl (LPSCl)) and a plurality of polytetrafluorethylene (PTFE) binder.

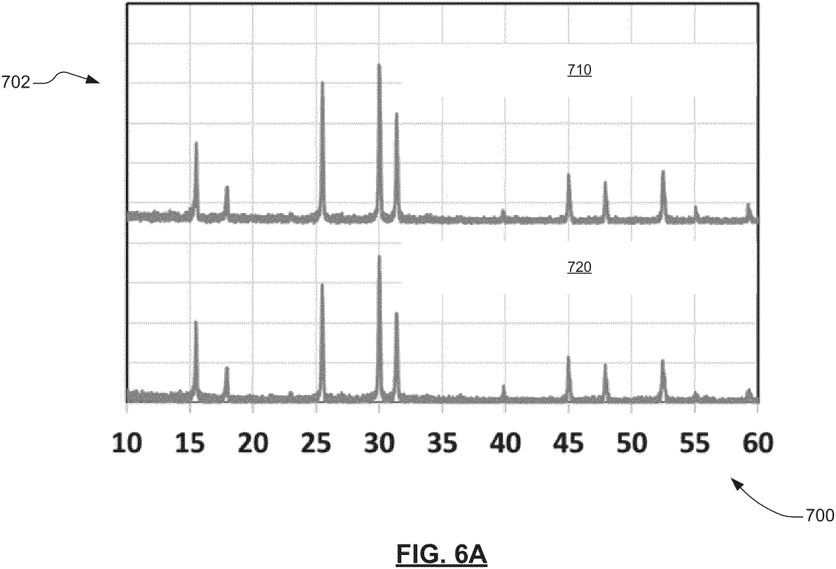

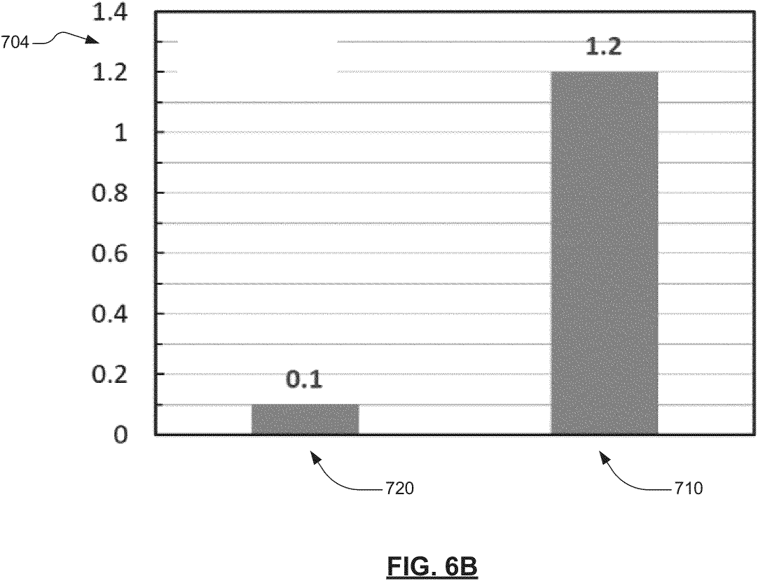

FIG. 6A is a graphical illustration representing the x-ray diffraction of the example electrolyte layer 710 as compared to the comparative electrolyte layer 720, where the x-axis 700 represents degrees (2θ) and the y-axis 702 represents intensity (a.u.). As illustrated, there are no additional impurity peaks in the instance of the example electrolyte layer 710 as compared to the to the comparative electrolyte layer 720, which indicates stability of the solid-state electrolyte particles towards the ionic liquid.

FIG. 6B is a graphical illustration demonstrating the ionic conductivity of the example electrolyte layer 710 as compared to the ionic conductivity of the comparative electrolyte layer 720, where the y-axis 704 represents ionic conductivity (mS/cm). As illustrated, the ionic conductivity of the example electrolyte layer 710 is about 1.2 mS/cm at 40° C., while the ionic conductivity of the comparative electrolyte layer 720 is about 0.1 mS/cm at 40° C.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A free-standing electrolyte layer for use in an electrochemical cell, the free-standing electrolyte layer comprising:
a plurality of solid-state electrolyte particles,
an ionic liquid that surrounds each solid-state electrolyte particle of the plurality of solid-state electrolyte particles, and
a plurality of polytetrafluoroethylene (PTFE) fibrils that provides a structural framework for the solid-state electrolyte particles, wherein the free-standing electrolyte layer has an ionic conductivity greater than or equal to about 0.1 mS/cm at 40° C. and a thickness greater than or equal to about 5 micrometers to less than or equal to about 500 micrometers.

2. The free-standing electrolyte layer of claim 1, wherein the free-standing electrolyte layer comprises:
greater than or equal to about to about 70 wt.% to less than or equal to about 99 wt.% of the plurality of solid-state electrolyte particles;
greater than or equal to about 0.1 wt.% to less than or equal to about 20 wt.% of the ionic liquid; and
greater than or equal to about 0.1 to less than or equal to about 10 wt.% of the plurality of polytetrafluoroethylene (PTFE) fibrils.

3. The free-standing electrolyte layer of claim 1, wherein the plurality of solid-state electrolyte particles are selected from the group consisting of: solid-state sulfide electrolyte particles, solid-state halide-based electrolyte particles, solid-state hydride-based solid-state electrolyte particles, and combinations thereof.

4. The free-standing electrolyte layer of claim 1, wherein the ionic liquid covers greater than or equal to about 2 % to less than or equal to about 100 % of the exposed surface each solid-state electrolyte particle of the plurality of solid-state electrolyte particles.

5. The free-standing electrolyte layer of claim 1, wherein the free-standing electrolyte layer has a porosity greater than or equal to about 0.1 vol.% to less than or equal to about 40 vol.%.

6. The free-standing electrolyte layer of claim 1, wherein the ionic liquid comprises a cation selected from the group consisting of: li(triglyme) ([Li(G3)]⁺), li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N-N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfloroethanesulfonyl)imide (BETI), bis(oxalate)borate (BOB), difluoro(oxalate)borate (DFOB), bis(floromalonato)borate (BFMB), and combinations thereof.

7. The free-standing electrolyte layer of claim 6, wherein the ionic liquid further comprises greater than 0 wt.% to less than or equal to about 70 wt.% of a dilute solvent.

8. The free-standing electrolyte layer of claim 7, wherein the dilute solvent is selected from the group consisting of: dimethyl carbonate, ethylene carbonate, ethyl acetate, acetonitrile, acetone, toluene, propylene carbonate, diethyl carbonate, 1,2,2-tetrafluoroethyl,2,2,3,3-tetrafluoropropyl ether, and combinations thereof.

9. The free-standing electrolyte layer of claim 1, wherein each of the polytetrafluoroethylene (PTFE) fibrils of the plurality of polytetrafluoroethylene (PTFE) fibrils has an average length of greater than or equal to about 2 micrometers to less than or equal to about 100 micrometers.

10. The free-standing electrolyte layer of claim 1, each of the polytetrafluoroethylene (PTFE) fibrils of the plurality of polytetrafluoroethylene (PTFE) fibrils has a softening point of greater than or equal to about 270° C. to less than or equal to about 380° C. and a molecular weight of greater than or equal to about 10⁵ g/mol to less than or equal to about 10⁹ g/mol.

11. An electrochemical cell that cycles lithium ions, the electrochemical cell comprising:
an electrolyte layer having an ionic conductivity greater than or equal to about 0.1 mS/cm at 40° C. and a thickness greater than or equal to about 5 micrometers to less than or equal to about 500 micrometers, wherein the electrolyte layer comprises:
a plurality of solid-state electrolyte particles;
an ionic liquid that covers greater than or equal to about 2 % to less than or equal to about 100 % of the exposed surface each solid-state electrolyte particle of the plurality of solid-state electrolyte particles; and
a plurality of polytetrafluoroethylene (PTFE) fibrils that provides a structural framework for the solid-state electrolyte particles, wherein each of the polytetrafluoroethylene (PTFE) fibrils of the plurality of polytetrafluoroethylene (PTFE) fibrils have an average length of greater than or equal to about 2 micrometers to less than or equal to about 100 micrometers.

12. The electrochemical cell of claim 11, wherein the plurality of solid-state electrolyte particles are selected from the group consisting of: solid-state sulfide electrolyte particles, solid-state halide-based electrolyte particles, solid-state hydride-based solid-state electrolyte particles, and combinations thereof.

13. The electrochemical cell of claim 11, wherein the plurality of solid-state electrolyte particles is a plurality of first solid-state electrolyte particles, the ionic liquid is a first ionic liquid, and the plurality of polytetrafluoroethylene (PTFE) fibrils is a first plurality of polytetrafluoroethylene (PTFE) fibrils, and wherein the electrochemical cell comprises:
at least one electrode, wherein the at least one electrode comprises:
a plurality of solid-state electroactive particles,
a plurality of second solid-state electrolyte particles,
a second ionic liquid that surrounds each of the solid-state electroactive particles and the second solid-state electrolyte particles, and
a second plurality of polytetrafluoroethylene (PTFE) fibrils that provides a structural framework for the solid-state electroactive particles and the second solid-state electrolyte particle.

14. The electrochemical cell of claim 13, wherein the at least one electrode is an at least one first electrode and the plurality of solid-state electroactive particles is a plurality of first solid-state electroactive particles, and wherein the electrochemical cell further comprises:
at least one second electrode, wherein the at least one second electrode comprises:
a plurality of second solid-state electroactive particles, wherein the second solid-state electroactive particles are different from the first solid-state electroactive particles,
a plurality of third solid-state electrolyte particles,
a third ionic liquid that surrounds each of the solid-state electroactive particles and the third solid-state electrolyte particles, and
a third plurality of polytetrafluoroethylene (PTFE) fibrils that provides a structural framework for the solid-state electroactive particles and the third solid-state electrolyte particle.

15. The electrochemical cell of claim 14, wherein the first ionic liquid, the second ionic liquid, and the third ionic liquid each comprises:
a cation selected from the group consisting of: li(triglyme) ([Li(G3)]⁺), li(tetraglyme) ([Li(G4)]⁺), 1-ethyl-3-methylimidazolium ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium ([MMMPyr]⁺), tetramethylammonium ([N₁₁₁₁]⁺), tetraethylammonium ([N₂₂₂₂]⁺), tributylmethylammonium ([N₄₄₄₁]⁺), diallyldimethylammonium ([DADMA]⁺), N-N-diethyl-N-methyl-N-(2-methoxyethyl)ammonium ([DEME]⁺), N,N-diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([Pᵢ₄₄₄]⁺), diethylmethylisobutyl-phosphonium ([Pᵢ₂₂₄]⁺), trihexdecylphosphonium ([P₆₆₆₁₀]⁺), trihexyltetradecylphosphonium ([P₆₆₆₁₄]⁺), and combinations thereof; and
an anion selected from the group consisting of: hexafluoroarsenate, hexafluorophosphate, bis(fluorosulfonyl)imide (FSI), bis(trifluoromethanesulfonyl)imide (TFSI), perchlorate, tetrafluoroborate, cyclo-difluoromethane-1,1-bis(sulfonyl)imide (DMSI), bis(perfloroethanesulfonyl)imide (BETI), bis(oxalate)borate (BOB), difluoro(oxalate)borate (DFOB), bis(floromalonato)borate (BFMB), and combinations thereof.

16. The electrochemical cell of claim 14, wherein at least one of the first ionic liquid, the second ionic liquid, and the third ionic liquid comprises a dilute solvent, wherein the dilute solvent is selected from the group consisting of: dimethyl carbonate, ethylene carbonate, ethyl acetate, acetonitrile, acetone, toluene, propylene carbonate, diethyl carbonate, 1,2,2-tetrafluoroethyl,2,2,3,3-tetrafluoropropyl ether, and combinations thereof.

17. A free-standing electrolyte layer for use in an electrochemical cell, the free-standing electrolyte layer comprising:
a plurality of solid-state electrolyte particles, wherein the plurality of solid-state electrolyte particles comprises solid-state sulfide electrolyte particles;
an ionic liquid; and
a plurality of polytetrafluoroethylene (PTFE) fibrils that provides a structural framework for the solid-state electrolyte particles, wherein each of the polytetrafluoroethylene (PTFE) fibrils of the plurality of polytetrafluoroethylene (PTFE) fibrils has an average length of greater than or equal to about 2 micrometers to less than or equal to about 100 micrometers, wherein the free-standing electrolyte layer has an ionic conductivity greater than or equal to about 0.1 mS/cm at 40° C., a thickness greater than or equal to about 5 micrometers to less than or equal to about 500 micrometers, and a porosity greater than or equal to about 0.1 vol.% to less than or equal to about 40 vol.%.

18. The free-standing electrolyte layer of claim 17, wherein the plurality of solid-state electrolyte particles further comprises:
solid-state halide-based electrolyte particles, solid-state hydride-based solid-state electrolyte particles, or a combination of solid-state halide-based electrolyte particles and solid-state hydride-based solid-state electrolyte particles.

19. The free-standing electrolyte layer of claim 17, wherein the ionic liquid covers greater than or equal to about 2% to less than or equal to about 100% of the exposed surface each solid-state electrolyte particle of the plurality of solid-state electrolyte particles.

20. The free-standing electrolyte layer of claim 17, wherein the plurality of polytetrafluoroethylene (PTFE) fibrils are prepared from a starting polytetrafluoroethylene (PTFE) material having an average particle size greater than or equal to about 2 micrometers to less than or equal to about 2,000 micrometers.
